(19) United States
(12) Patent Application Publication
(10) Pub. No.: US 2026/0142166 A1
(43) Pub. Date: May 21, 2026

(54) POSITIVE ELECTRODE ACTIVE MATERIAL AND METHOD FOR PRODUCING POSITIVE ELECTRODE ACTIVE MATERIAL

(71) Applicant: TOYOTA JIDOSHA KABUSHIKI KAISHA, Toyota-shi (JP)

(72) Inventors: Momoko PROCTER, Seto-shi (JP); Yuji Mahara, Seto-shi (JP)

(73) Assignee: TOYOTA JIDOSHA KABUSHIKI KAISHA, Toyota-shi (JP)

(21) Appl. No.: 19/357,784

(22) Filed: Oct. 14, 2025

(30) Foreign Application Priority Data
Nov. 15, 2024 (JP) 2024-199556

(51) Int. Cl. H01M 4/525; C01G 53/506

(52) U.S. Cl. CPC H01M 4/525; C01G 53/506; C01P 2002/50; C01P 2004/45; C01P 2006/40

(57) ABSTRACT

A positive electrode active material includes a lithium transition metal composite oxide having a lamellar structure; in a volume-based particle size distribution of the positive electrode active material, a relation: 0.1<f₂/f₁≤25 is satisfied, where f₁ is a maximum frequency in a range where a maximum Feret diameter is 1 μm or more and 3 μm or less, and f₂ is a maximum frequency in a range where the maximum Feret diameter is 5 μm or more and 25 μm or less.

### CROSS REFERENCE TO RELATED APPLICATIONS

This nonprovisional application is based on Japanese Patent Application No. 2024-199556 filed on Nov. 15, 2024 with the Japan Patent Office, the entire contents of which are hereby incorporated by reference.

### BACKGROUND

### Field

The present disclosure relates to a positive electrode active material and a method for producing a positive electrode active material.

### Description of the Background Art

Japanese Patent Laying-Open No. 2024-65999 discloses a positive electrode active material for a lithium-ion secondary battery in which the ratio of the content of boron (B) to the content of carbon (C) is within a predetermined range and the variation in particle size is within a predetermined range.

### SUMMARY

The positive electrode active material disclosed in Japanese Patent Laying-Open No. 2024-65999 contains B at a predetermined ratio to thereby reduce the content of a compound that causes increase in resistance, such as lithium carbonate, and reduce the reaction resistance. In addition, the variation in particle size of the positive electrode active material is configured to fall within a predetermined range, to thereby suppress mixture of coarse particles and fine particles, and increase the output resistance.

However, there is still room for improvement in reducing the initial resistance.

An object of the present disclosure is to reduce the initial resistance.
[1]A positive electrode active material including a lithium transition metal composite oxide having a lamellar structure, wherein
in a volume-based particle size distribution of the positive electrode active material, a relation: 0.1<f₂/f₁≤25 is satisfied, where
   f₁ is a maximum frequency in a range where a maximum Feret diameter is 1 μm or more and 3 μm or less, and
   f₂ is a maximum frequency in a range where the maximum Feret diameter is 5 μm or more and 25 μm or less.

The positive electrode active material satisfying the relation as described above in [1] can be used to increase contact between the positive electrode active materials, that is, increase an electrically conductive path. Thus, reduction of the initial resistance is expected.
[2] The positive electrode active material according to [1], wherein in the volume-based particle size distribution of the positive electrode active material, a relation: 0.5≤f₂/f₁≤3.0 is satisfied.

The positive electrode active material satisfying the relation as described above in [2] can be used so that improvement in durability is expected in addition to reduction in initial resistance.
[3] The positive electrode active material according to [1] or [2], wherein the positive electrode active material includes monocrystal particles and polycrystal particles formed by aggregation of the monocrystal particles.
[4] The positive electrode active material according to any one of [1] to [3], wherein
the lithium transition metal composite oxide has a composition represented by a general formula:

LiₓNiₐCo_{b}Mn_{c}O_{y},

and
relations: 0.1≤x≤1.5, 0.5≤a≤1.0, 0≤b≤0.3, 0≤c≤0.3, a+b+c=1.0, and 1.5≤y≤2.1 are satisfied.
[5]A method for producing a positive electrode active material according to [1], the method including:
(a) preparing a precursor;
(b) mixing the precursor and a lithium compound to prepare a mixture;
(c) calcining the mixture to prepare a calcined product; and
(d) washing the calcined product to prepare the positive electrode active material, wherein
the precursor includes a transition metal compound,
the transition metal compound includes at least nickel, and
a ratio in an amount of substance of lithium in the lithium compound, to a total amount of substance of a transition metal in the transition metal compound is more than 1.0 and less than 2.0.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic flowchart showing a method for producing a positive electrode active material in the present embodiment.

FIG. 2 is a schematic view showing the lithium-ion secondary battery of the present embodiment.

FIG. 3 is a table showing experimental results.

FIG. 4 is an example of a volume-based particle size distribution of a positive electrode active material.

### DESCRIPTION OF THE PREFERRED EMBODIMENTS

Hereinafter, embodiments of the present disclosure (hereinafter, it may be abbreviated as “the present embodiment”) and examples of the present disclosure (hereinafter, it may be abbreviated as “the present example”) will be described.

However, the present embodiment and the present example do not limit the technical scope of the present disclosure.

The chemical composition of the positive electrode active material can be measured by ICP-AES (Inductively coupled Plasma atomic emission spectroscopy).

A sample solution is prepared by dissolving 0.1 g of a sample (positive electrode active material) in a mixed acid of hydrochloric acid and sulfuric acid (10 ml). The sample solution is diluted to an appropriate concentration with a volumetric flask. After dilution, compositional analysis is performed by an ICP-AES instrument. For example, the product name “PS3520 UVDD II (manufactured by Hitachi High-Tech Science Corporation)” or the like may be used.

In the present specification, when a compound is represented by a stoichiometric composition formula such as “LiCoO₂”, the stoichiometric composition formula is merely a representative example. For example, when lithium cobaltate is expressed as “LiCoO₂”, unless otherwise specified, lithium cobaltate is not limited to a composition ratio of “Li/Co/O=1/1/2”, and may contain Li, Co, and O at an arbitrary composition ratio. The composition ratio may be non-stoichiometric.

In the present specification, the volume-based particle size distribution can be measured by a laser diffraction particle size distribution measuring apparatus. The measurement procedure may be as follows. A measurement target (positive electrode active material) is prepared. The measurement sample (particle dispersion) is prepared by mixing the measurement target and the dispersion medium. The volume-based particle size distribution is measured by introducing the measurement sample into a laser diffraction particle size distribution measuring apparatus.

As used herein, the term “maximum Feret diameter” refers to the distance between the two farthest points on the contour of a particle. The maximum Feret diameter is measured in a scanning electron microscope (SEM) image.

### <Positive Electrode Active Material>

The positive electrode active material of the present embodiment can reversibly occlude and release lithium ions. The positive electrode active material includes a lithium transition metal composite oxide having a lamellar structure. The positive electrode active material may be a positive electrode active material made of a lithium transition metal composite oxide having a lamellar structure. The lithium transition metal composite oxide includes lithium (Li), a transition metal (TM), and oxygen (O). TM contains at least nickel (Ni). The lithium transition metal composite oxide may be, for example, at least one selected from the group consisting of LiNiO₂, Li(NiCoMn)O₂, and Li(NiCoAl)O₂. Among these, Li(NiCoMn)O₂ is preferable because it has particularly excellent resistance characteristics. Such a lithium transition metal composite oxide preferably has a composition represented by the following general formula.

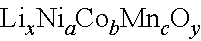

In the above formula, the relations: 0.1≤x≤1.5, 0.5≤a≤1.0, 0≤b≤0.3, 0≤c≤0.3, a+b+c=1.0, and 1.5≤y≤2.1 are satisfied.

In the volume-based particle size distribution of the positive electrode active material, a relation: 0.1<f₂/f₁<25 is satisfied. f₁ is a maximum frequency (%) in a range where the maximum Feret diameter is 1 μm or more and 3 μm or less, and f₂ is a maximum frequency (%) in a range where the maximum Feret diameter is 5 μm or more and 25 μm or less.

By using the positive electrode active material satisfying such a relation, contact between the positive electrode active materials, that is, an electrically conductive path can be increased. This is expected to reduce the initial resistance.
f₂/f₁ may be, for example, 0.3 or more, 0.33 or more, 0.5 or more, 0.58 or more, 1.0 or more, 1.5 or more, or 2.0 or more. f₂/f₁ may be, for example, 20.5 or less, 20 or less, 15 or less, 10 or less, 5.33 or less, 5.0 or less, or 3.0 or less. For example, f₂/f₁ may satisfy a relation: 0.5<f₂/f₁<3.0. As a result, in addition to a reduction in the initial resistance, an improvement in durability is expected. For example, f₂/f₁ may satisfy a relation: 2.0<f₂/f₁<3.0. As a result, further improvement in durability is expected.
f₁ may be, for example, 0.3 or more, 0.5 or more, 1.0 or more, 1.5 or more, 1.98 or more, or 2.0 or more. f₁ may be, for example, 7.0 or less, 6.0 or less, 5.5 or less, 5.0 or less, 4.5 or less, 4.0 or less, or 3.5 or less. f₂ may be, for example, 0.75 or more, 1.0 or more, 1.5 or more, 2.0 or more, 2.5 or more, 3.0 or more, 3.5 or more, or 4.0 or more. f₂ may be, for example, 10 or less, 9.0 or less, 8.5 or less, 8.0 or less, 7.5 or less, 7.0 or less, 6.5 or less, or 6.0 or less.

One peak may appear in the volume-based particle size distribution of the positive electrode active material. The peak may be in the range of 1 μm or more and 3 μm or less, or in the range of 5 μm or more and 25 μm or less.

Two peaks may appear in the volume-based particle size distribution of the positive electrode active material. One of the two peaks may be a main peak and the other thereof may be a shoulder peak (sub-peak). The peak top of the main peak is higher than the peak top of the shoulder peak. When the peak top of the main peak is in the range of 1 μm or more and 3 μm or less, the peak top of the shoulder peak may be in the range of 5 μm or more and 25 μm or less. When the peak top of the main peak is in the range of 5 μm or more and 25 μm or less, the peak top of the shoulder peak may be in the range of 1 μm or more and 3 μm or less.

The positive electrode active material may include monocrystal particles and polycrystal particles. The polycrystal particle is formed by aggregation (gathering) of a plurality of monocrystal particles. Monocrystal particles and polycrystal particles can be confirmed by SEM images. In the present embodiment, the compositions of the monocrystal particles and the polycrystal particles are the same.

The monocrystal particles are so-called small particles. The monocrystal particle is an independent particle which is not aggregated, is substantially composed of a single particle, and refers to a particle in which a grain boundary cannot be confirmed in an SEM image. The monocrystal particle has a particle size relatively smaller than that of the polycrystal particle.

The polycrystal particles are so-called large particles. The polycrystal particle refers to a particle formed by aggregating (gathering) a plurality of monocrystal particles. The polycrystal particle has a particle size relatively larger than that of the monocrystal particle.

The monocrystal particles may have a maximum Feret diameter of 1 μm or more and 3 μm or less. That is, f₁ may be the maximum frequency of the monocrystal particles. The polycrystal particles may have a maximum Feret diameter of 5 μm or more and 25 μm or less. That is, f₂ may be the maximum frequency of the polycrystal particles.

The polycrystal particles in the present embodiment are different from conventional polycrystal particles. Both can be discriminated by, for example, the maximum Feret diameter or aspect ratio of the monocrystal particles confirmed from the SEM image. For example, the monocrystal particles included in the polycrystal particles in the present embodiment may have a maximum Feret diameter equivalent to that of the monocrystal particles present alone. On the other hand, it is believed that monocrystal particles contained in conventional polycrystal particles can have a smaller maximum Feret diameter than monocrystal particles present alone.

When the positive electrode active material includes monocrystal particles and polycrystal particles, the positive electrode active material in the present embodiment is different from a conventional positive electrode active material in which monocrystal particles and polycrystal particles are mixed. Both can be distinguished, for example, by the maximum Feret diameter of the monocrystal particles confirmed from the SEM image. For example, the average value of the maximum Feret diameters of the monocrystal particles included in the polycrystal particles and the average value of the maximum Feret diameters of the monocrystal particles present alone fall within the range of 10%. On the other hand, in the conventional positive electrode active material, it is considered that the maximum Feret diameter between the monocrystal particle contained in the polycrystal particle and the monocrystal particle present alone does not fall within the above range.

When the positive electrode active material includes monocrystal particles and polycrystal particles, the content ratio of the monocrystal particles to the polycrystal particles in the positive electrode active material is not particularly limited. The mass ratio therebetween (monocrystal particles:polycrystal particles) may be, for example, 10:90 to 90:10, 20:80 to 80:20, 30:70 to 70:30, or 40:60 to 60:40. The positive electrode active material may be composed of only monocrystal particles and polycrystal particles.

### <Method for Producing Positive Electrode Active Material>

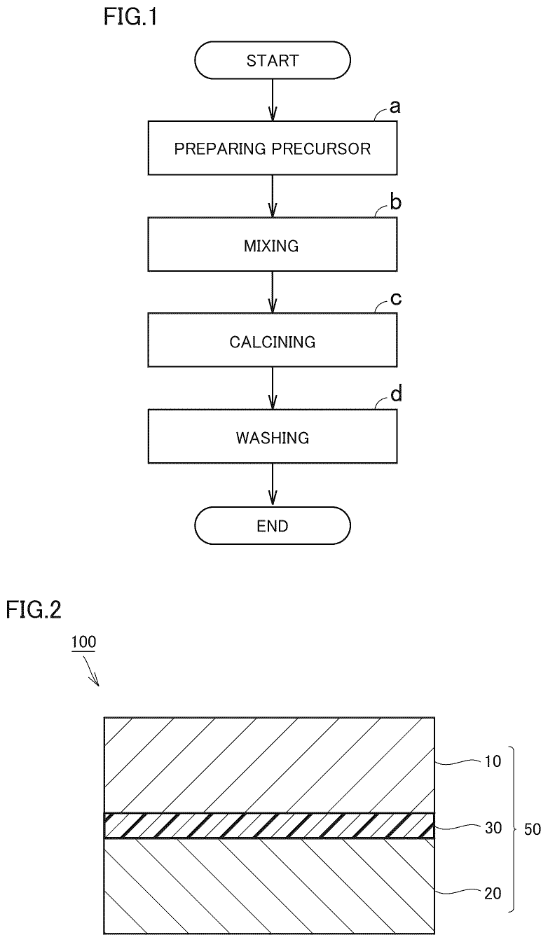

FIG. 1 is a schematic flowchart of a method for producing a positive electrode active material in the present embodiment. Hereinafter, the method for producing a positive electrode active material in the present embodiment may be abbreviated as “the present production method”. The present production method includes “(a) preparing a precursor”, “(b) mixing”, “(c) calcining”, and “(d) washing”.

((a)Preparing Precursor)

The present production method includes preparing a precursor. The precursor may be synthesized by, for example, a coprecipitation method, a hydrothermal synthesis method, or the like. The precursor includes a transition metal compound. The transition metal compound includes at least Ni. The precursor may include, for example, a transition metal hydroxide containing Ni. For example, a raw material solution is prepared by dissolving a transition metal compound in water. Precipitation of the transition metal hydroxide can be generated by dropping the raw material solution into the alkaline aqueous solution. For example, the precipitate (transition metal hydroxide) may be washed with water. After washing with water, the transition metal hydroxide may be recovered by filtration. After filtration, the transition metal hydroxide may be dried.

After completion of the precipitation reaction, the transition metal hydroxide may be subjected to pre-calcining. Dehydration of the transition metal hydroxide, removal of impurities, and the like can be performed by performing pre-calcining. In the present production method, any calcination apparatus or calcination furnace may be used. For example, a muffle furnace, an electric furnace, or the like may be used. The pre-calcining may be performed under an oxygen atmosphere, for example.

The temperature of the pre-calcining may be, for example, 120° C. or higher, or 150° C. or higher. The temperature of the pre-calcining may be, for example, 220° C. or lower, or 200° C. or lower. The pre-calcining time may be, for example, 4 hours or more, or 6 hours or more. The pre-calcining time may be, for example, 10 hours or less, or 8 hours or less. The pre-calcining pressure may be, for example, 0.2 MPa or more, or 0.5 MPa or more. The pre-calcining pressure may be, for example, 1.0 MPa or less, or 0.8 MPa or less.

### ((b) Mixing)

The present production method includes preparing a mixture by mixing a precursor and a lithium compound. For example, grinding and mixing may be performed in a mortar or the like. The lithium compound is a compound containing Li. The lithium compound may contain, for example, at least one selected from the group consisting of LiGH and Li₂CO₃. The lithium compound is a lithium source of the lithium transition metal composite oxide. The ratio in amount of substance of Li in the lithium compound to the total amount of substance of TM in the precursor (transition metal compound) (hereinafter, it may be simply abbreviated as “charge ratio”) is more than 1.0 and less than 2.0. The charge ratio may be, for example, 1.05 or more, 1.1 or more, or 1.2 or more. The charge ratio may be, for example, 1.8 or less, 1.6 or less, or 1.4 or less.

### ((c) Calcining)

The present production method includes calcining the mixture (hereinafter, this may also be referred to as “main calcining”) to prepare a calcined product. The same calcination apparatus and calcination furnace as those for the pre-calcining may be used. The main calcining may be performed under an oxygen atmosphere, for example.

The temperature of the main calcining may be, for example, 650° C. or higher, or 700° C. or higher. The temperature of the main calcining may be, for example, 1100° C. or less, or 1000° C. or less. The temperature of the main calcining is higher than the temperature of the pre-calcining. The main calcining time may be, for example, 5 hours or more, 7 hours or more, or 10 hours or more. The main calcining time may be, for example, 15 hours or less, 12 hours or less, or 10 hours or less. The time of the main calcining is longer than the time of the pre-calcining.

### ((d) Washing)

The present production method includes washing the calcined product to prepare a positive electrode active material (lithium transition metal composite oxide).

For example, the calcined product may be washed with water. For example, the calcined product may be disintegrated and then washed in a mortar or the like. After washing, the calcined product may be filtered and dried. Washing may remove excess Li.

### ((e) Disintegration)

The present production method may include disintegrating the positive electrode active material (lithium transition metal composite oxide). Any grinder (e.g., mortar, lab mill, etc.) may be used. The particle size of the positive electrode active material (lithium transition metal composite oxide) can be adjusted by disintegration.

### <Lithium-Ion Secondary Battery>

FIG. 2 is a schematic view showing a lithium-ion secondary battery (hereinafter, it may be abbreviated as “battery”) according to the present embodiment. The battery 100 includes a power generating element 50 and an electrolyte solution (not shown).

The battery 100 may include an exterior package. The exterior package may contain the power generating element 50 and the electrolyte solution. The exterior package may be, for example, a metal case or a pouch made of an Al laminate film.

The power generating element 50 may have any form. The power generating element 50 may be, for example, a wound type, a stack type, or the like. The power generating element 50 may have a monopolar structure or a bipolar structure. The power generating element 50 includes a positive electrode 10, a negative electrode 20, and a separator 30. The separator 30 is disposed between the positive electrode 10 and the negative electrode 20. The electrolyte solution permeates the voids between the members and the voids in the members. Each member may be in the form of a sheet, for example.

### (Positive Electrode)

The positive electrode 10 includes a positive electrode active material. That is, the battery 100 includes a positive electrode active material. For example, the positive electrode 10 may include a positive electrode current collector and a positive electrode active material layer. The positive electrode current collector supports the positive electrode active material layer. The positive electrode current collector may include, for example, an Al foil or the like.

The positive electrode active material layer contains a positive electrode active material. Details of the positive electrode active material are as described above.

The positive electrode active material layer may further contain, for example, a conductive material, a binder, or the like. The conductive material may include, for example, acetylene black (AB). The binder may include, for example, PVDF. The conductive material and the binder may be, for example, 0.1 mass % or more and 10 mass % or less with respect to the positive electrode active material layer.

### (Negative Electrode)

The negative electrode 20 may include a negative electrode current collector and a negative electrode active material layer. The negative electrode current collector may include, for example, a copper (Cu) foil or the like. The negative electrode active material layer includes a negative electrode active material. The negative electrode active material may contain, for example, at least one selected from the group consisting of graphite, soft carbon, and hard carbon. The negative electrode active material layer may further contain, for example, a conductive material, a binder, or the like.

The conductive material may include, for example, carbon nanotubes (CNTs) or the like. The binder may include, for example, carboxymethyl cellulose (CMC), styrene-butadiene rubber (SBR), or the like. The blending amount of the conductive material and the binder may be, for example, 0.1 to 10 parts by mass with respect to 100 parts by mass of the negative electrode active material.

### (Separator)

The separator 30 is porous. The separator 30 can permeate the electrolyte solution. The separator 30 separates the positive electrode 10 from the negative electrode 20. The separator 30 is electrically insulating. The separator 30 may include, for example, a polyolefin-based resin such as polyethylene (PE) or polypropylene (PP). The separator 30 may have, for example, a single-layer structure or a multilayer structure. The separator 30 may be substantially composed of, for example, a PE layer, or may be formed by stacking a PP layer, a PE layer, and a PP layer in this order. For example, a heat-resistant layer may be formed on the surface of the separator 30.

### (Electrolyte Solution)

The electrolyte solution includes a solvent and a Li salt. The solvent is aprotic. The solvent may contain any ingredient. The solvent may include, for example, at least one selected from the group consisting of ethylene carbonate (EC), dimethyl carbonate (DMC), and ethyl methyl carbonate (EMC).

The Li salt is a supporting electrolyte. The Li salt is dissolved in the solvent. The Li salt may contain, for example, at least one selected from the group consisting of LiPF₆ and LiBF₄. The Li salt may have a molar concentration of, for example, 0.5 mol/L or more and 2.0 mol/L or less.

The electrolyte solution may further contain an optional additive. The electrolyte solution may contain, for example, 0.01 mass % or more and 5 mass % or less of an additive. The additive may include, for example, at least one selected from the group consisting of vinylene carbonate (VC), vinylethylene carbonate (VEC), and the like. Instead of the electrolyte solution, a solid electrolyte may be used.

### EXAMPLES

### <Production of Positive Electrode Active Material>

### (No. 1 to No. 7)

NiSO₄, CoSO₄, and MnSO₄ were dissolved in ion-exchanged water to form a raw material solution. In the raw material solution, the mixing ratio (ratio in substance amount) of Ni, Co, and Mn was “Ni/Co/Mn=90/5/5”. The substance amount concentration of the raw material solution was 0.2%.

The reaction vessel was charged with ammonia water. While the ammonia water was stirred by a stirrer, the inside of the reaction vessel was replaced with nitrogen. Further, NaOH was charged into the reaction vessel to form a reaction solution. The raw material solution and ammonia water were added dropwise to the reaction solution so that the pH of the reaction solution was maintained in a certain range, whereby precipitation of the transition metal hydroxide was formed.

The metal hydroxide was calcined in a muffle furnace. The pre-calcining temperature was 120 to 220° C., the pre-calcining time was 4 to 10 hours, and the pre-calcining pressure was 0.2 to 1.0 MPa. After the pre-calcining, the transition metal hydroxide was dispersed in ion-exchanged water to form a dispersion. The dispersion was sufficiently stirred by a spatula. That is, the transition metal hydroxide was washed with water. After washing with water, a transition metal hydroxide was recovered by filtration. The transition metal hydroxide was dried at 110° C. for 12 hours to prepare a precursor (transition metal hydroxide).

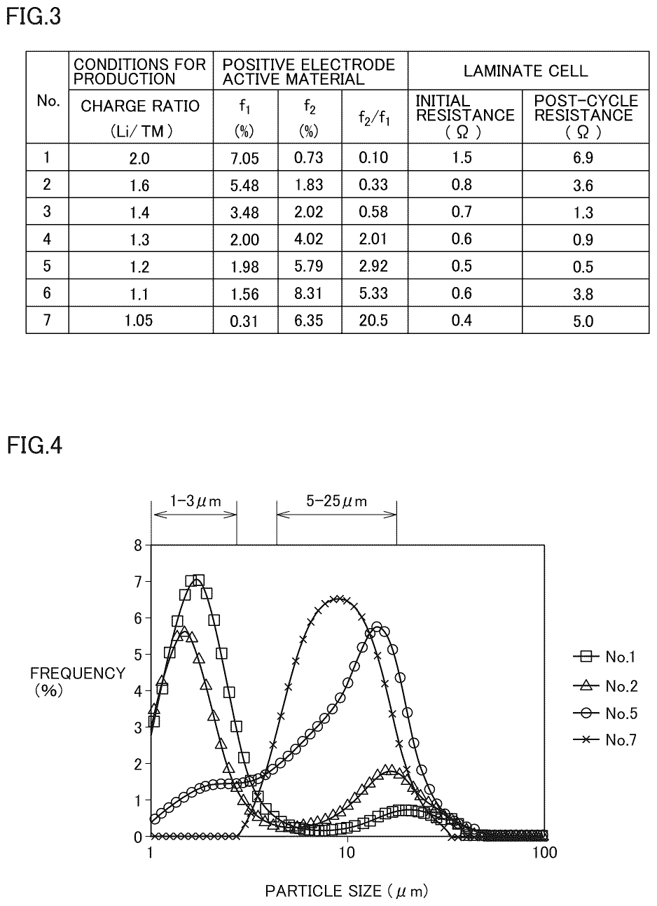

The precursor (transition metal hydroxide) and LiGH were mixed in a mortar to prepare a mixture. The charge ratio was adjusted to a value shown in FIG. 3.

The mixture was subjected to main calcining in a muffle furnace to prepare a calcined product. The temperature of the main calcining was 650 to 1100° C., and the time of the main calcining was 5 to 15 hours.

In an agate mortar, the calcined product was disintegrated until the particle size became 0.2 mm or less, thereby forming a disintegrated product. The disintegrated product was dispersed in 500 mL of pure water to form a slurry. The slurry was stirred vigorously for 1 min. The slurry was filtered through filter paper and Buchner funnel. The residue was rinsed with 500 mL of pure water to form a cake. The cake was vacuum dried at 90° C. After drying, the cake was disintegrated using an agate mortar to adjust to a predetermined particle size. Thus, the positive electrode active materials (lithium transition metal composite oxides) of No. 1 to No. 7 were produced.

### (Analysis)

The composition of the positive electrode active material of each No. was confirmed by an ICP emission spectrophotometer (PS3520UVDD, manufactured by Hitachi High-Tech Science Corporation). It was confirmed that each positive electrode active material had a composition “LiNi_{0.90}Co_{0.05}Mn_{0.05}O₂”. Further, as a result of confirming the crystal structure of each No., it was confirmed that each positive electrode active material had a lamellar crystal structure.

The volume-based particle size distribution of the positive electrode active material of each No. was measured with a laser diffraction particle size distribution measuring apparatus (WingSALD-2300, manufactured by Shimadzu Corporation). FIG. 3 shows f₁, f₂, and f₂/f₁ in the positive electrode active material of each No. As an example, the volume-based particle size distributions of the positive electrode active materials of Nos. 1, 2, 5, and 7 are shown in FIG. 4.

### <Evaluation>

### (Production of Laminate Cell)

A laminate cell was produced. The laminate cell has the following structure.

Positive electrode: positive electrode active material (lithium transition metal composite oxide) and conductive material (AB)

Negative electrode: negative electrode active material (natural graphite)

Electrolyte: LiPF₆ (1 mol/L), EC/DMC/EMC=3/4/3 (volume ratio)

The positive electrode and the negative electrode were produced by coating the surface of a base material (metal foil) with a slurry. As the coating apparatus, a film applicator (with a film thickness adjusting function) manufactured by Allgood Co., Ltd. was used. After the slurry was applied, the coating film was dried at 80° C. for 5 minutes.

The laminate cell was subjected to a cycle test under the following conditions.
Ambient Temperature: 60° C.
Number of Cycles: 100
Current Rate: 0.3 C
Voltage Range: from 4.25 V to 2.5 V

Each laminate cell before and after the cycle test was charged to an SOC (State of Charge) of 50%, and then discharged and charged at a rate of 0.3 C, 0.5 C, 0.7 C, and 1 C at 25° C., and an average of resistances estimated from a potential drop and increase after 0.1 seconds was defined as an IV resistance. The results are shown in FIG. 3. In FIG. 3, the IV resistance before the cycle test is referred to as “initial resistance”, and the IV resistance after the cycle test is referred to as “post-cycle resistance”. Note that “1 C” indicates a current rate at which the SOC reaches 100% from 0% after charging for one hour.

### <Results>

In FIG. 3, when the relation “0.1<f₂/f₁<25” is satisfied, the initial resistance tends to decrease. When the relation “0.5 f₂/f₁<3.0” is satisfied, there is a tendency that the post-cycle resistance is reduced, that is, the durability is improved, in addition to the reduction of the initial resistance. Further, when the relation “2.0 f₂/f₁<3.0” is satisfied, the durability tends to be further improved.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A positive electrode active material comprising a lithium transition metal composite oxide having a lamellar structure, wherein
in a volume-based particle size distribution of the positive electrode active material, a relation: 0.1<f₂/f₁<25 is satisfied, where
f₁ is a maximum frequency in a range where a maximum Feret diameter is 1 μm or more and 3 μm or less, and
f₂ is a maximum frequency in a range where the maximum Feret diameter is 5 μm or more and 25 μm or less.

2. The positive electrode active material according to claim 1, wherein in the volume-based particle size distribution of the positive electrode active material, a relation: 0.5≤f₂/f₁<3.0 is satisfied.

3. The positive electrode active material according to claim 1, wherein the positive electrode active material includes monocrystal particles and polycrystal particles formed by aggregation of the monocrystal particles.

4. The positive electrode active material according to claim 1, wherein
the lithium transition metal composite oxide has a composition represented by a general formula:
LiₓNiₐCo_{b}Mn_{c}O_{y},
and
relations: 0.1≤x≤1.5, 0.5≤a≤1.0, 0≤b≤0.3, 0≤c≤0.3, a+b+c=1.0, and 1.5≤y≤2.1 are satisfied.

5. A method for producing a positive electrode active material according to claim 1, the method comprising:
(a) preparing a precursor;
(b) mixing the precursor and a lithium compound to prepare a mixture;
(c) calcining the mixture to prepare a calcined product; and
(d) washing the calcined product to prepare the positive electrode active material, wherein
the precursor includes a transition metal compound,
the transition metal compound includes at least nickel, and
a ratio in an amount of substance of lithium in the lithium compound, to a total amount of substance of a transition metal in the transition metal compound is more than 1.0 and less than 2.0.
